(19) United States
(12) Patent Application Publication
(10) Pub. No.: US 2025/0347871 A1
(43) Pub. Date: Nov. 13, 2025

(54) OPTICAL DEVICE AND METHOD OF MANUFACTURE

(71) Applicant: Taiwan Semiconductor Manufacturing Co., Ltd., Hsinchu (TW)

(72) Inventors: Chen-Hua Yu, Hsinchu (TW); Tsung-Fu Tsai, Changhua City (TW); Chao-Jen Wang, Hsinchu (TW); Tung-Liang Shao, Hsinchu (TW); Szu-Wei Lu, Hsinchu (TW)

(21) Appl. No.: 19/276,534

(22) Filed: Jul. 22, 2025

Related U.S. Application Data
(63) Continuation of application No. 18/619,983, filed on Mar. 28, 2024.
(60) Provisional application No. 63/603,810, filed on Nov. 29, 2023.

(51) Int. Cl. G02B 6/42

(52) U.S. Cl. CPC G02B 6/4214; G02B 6/423

(57) ABSTRACT

Optical devices and methods of manufacture are presented in which an alignment die is utilized to provide alignment for a passive optical device. A manufacturing process of one embodiment includes placing an alignment die adjacent to a first optical package; and attaching a first passive optical device to both the alignment die and the first optical package, wherein a first alignment structure of the first passive optical device is conjoined with a second alignment structure of the alignment die.

### PRIORITY CLAIM AND CROSS-REFERENCE

This application is a continuation of U.S. patent application Ser. No. 18/619,983, filed on Mar. 28, 2024, which application claims the benefit of U.S. Provisional Application No. 63/603,810, filed on Nov. 29, 2023, entitled “Passive Alignment FAU Design,” which applications are hereby incorporated herein by reference.

### BACKGROUND

Electrical signaling and processing is one technique for signal transmission and processing. Optical signaling and processing have been used in increasingly more applications in recent years, particularly due to the use of optical fiber-related applications for signal transmission.

Optical signaling and processing are typically combined with electrical signaling and processing to provide full-fledged applications. For example, optical fibers may be used for long-range signal transmission, and electrical signals may be used for short-range signal transmission as well as processing and controlling. Accordingly, devices integrating long-range optical components and short-range electrical components are formed for the conversion between optical signals and electrical signals, as well as the processing of optical signals and electrical signals. Packages thus may include both optical (photonic) dies including optical devices and electronic dies including electronic devices.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1-9 illustrate formation of a first optical package, in accordance with some embodiments.

FIGS. 10A-10B illustrate a placement of an alignment die, in accordance with some embodiments.

FIGS. 11A-11C illustrate placement of a first passive optical device, in accordance with some embodiments.

FIGS. 12A-12D illustrate placement of a receptacle, in accordance with some embodiments.

FIG. 13 illustrates a fiber array unit, in accordance with some embodiments.

FIG. 14 illustrates an insertion of the fiber array unit, in accordance with some embodiments.

FIG. 15 illustrates a second embodiment of the alignment die, in accordance with some embodiments.

FIG. 16 illustrates placement of the receptacle over the second embodiment of the alignment die, in accordance with some embodiments.

FIG. 17 illustrates a fiber array unit with a spring, in accordance with some embodiments.

FIG. 18 illustrates an insertion of the fiber array unit with the spring, in accordance with some embodiments.

FIGS. 19A-19D illustrate a detachable structure connected to the fiber array unit, in accordance with some embodiments.

FIGS. 20A-20B illustrate an insertion of the fiber array unit with the detachable structure, in accordance with some embodiments.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Embodiments will now be discussed with respect to certain embodiments in which an alignment die is utilized in order to provide a passive alignment of other structures within an optical system. The embodiments presented, however, are intended to be illustrative and are not intended to limit the ideas presented to the precise embodiments described. Rather, the ideas presented may be incorporated into a wide variety of embodiments, and all such embodiments may be included within the overall scope of the disclosure.

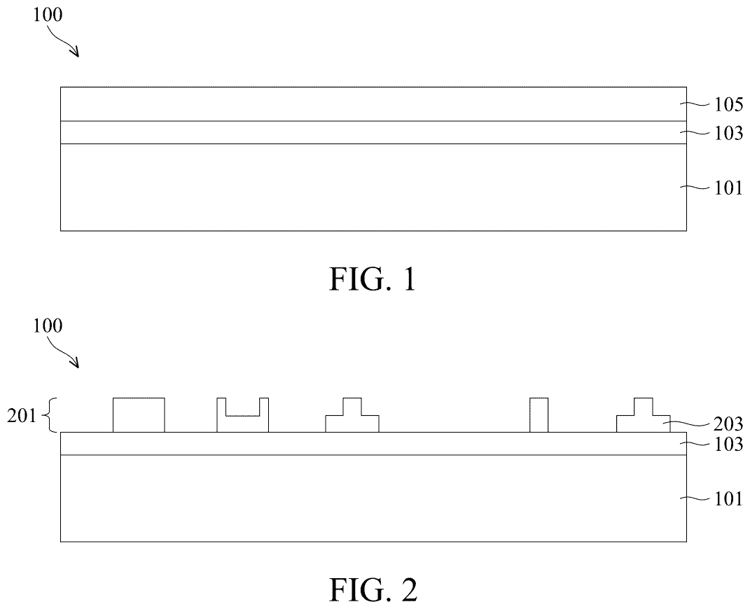

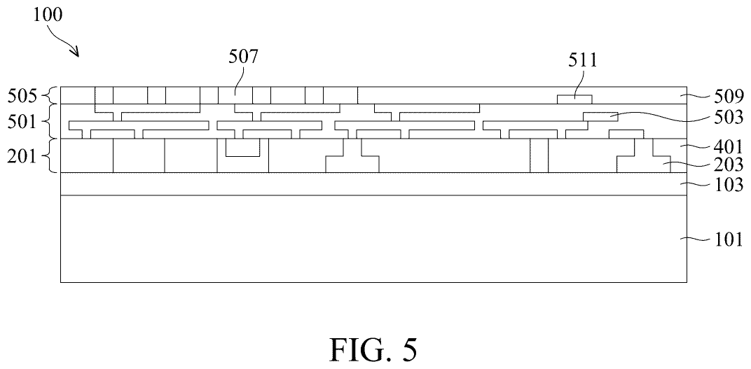

With reference now to FIG. 1, there is illustrated an initial structure of an optical interposer 100 (seen in FIG. 5), in accordance with some embodiments. In the particular embodiment illustrated in FIG. 1, the optical interposer 100 is a photonic integrated circuit (PIC) and comprises at this stage a first substrate 101, a first insulator layer 103, and a layer of material 105 for a first active layer 201 of first optical components 203 (not separately illustrated in FIG. 1 but illustrated and discussed further below with respect to FIG. 2). In an embodiment, at a beginning of the manufacturing process of the optical interposer 100, the first substrate 101, the first insulator layer 103, and the layer of material 105 for the first active layer 201 of first optical components 203 may collectively be part of a silicon-on-insulator (SOI) substrate. Looking first at the first substrate 101, the first substrate 101 may be a semiconductor material such as silicon or germanium, a dielectric material such as glass, or any other suitable material that allows for structural support of overlying devices.

The first insulator layer 103 may be a dielectric layer that separates the first substrate 101 from the overlying first active layer 201 and can additionally, in some embodiments, serve as a portion of cladding material that surrounds the subsequently manufactured first optical components 203 (discussed further below). In an embodiment the first insulator layer 103 may be silicon oxide, silicon nitride, germanium oxide, germanium nitride, combinations of these, or the like, formed using a method such as implantation (e.g., to form a buried oxide (BOX) layer) or else may be deposited onto the first substrate 101 using a deposition method such as chemical vapor deposition, atomic layer deposition, physical vapor deposition, combinations of these, or the like. However, any suitable material and method of manufacture may be used.

The material 105 for the first active layer 201 is initially (prior to patterning) a conformal layer of material that will be used to begin manufacturing the first active layer 201 of the first optical components 203. In an embodiment the material 105 for the first active layer 201 may be a translucent material that can be used as a core material for the desired first optical components 203, such as a semiconductor material such as silicon, germanium, silicon germanium, combinations of these, or the like, while in other embodiments the material 105 for the first active layer 201 may be a dielectric material such as silicon nitride or the like, although in other embodiments the material 105 for the first active layer 201 may be III-V materials, lithium niobate materials, or polymers. In embodiments in which the material 105 of the first active layer 201 is deposited, the material 105 for the first active layer 201 may be deposited using a method such as epitaxial growth, chemical vapor deposition, atomic layer deposition, physical vapor deposition, combinations of these, or the like. In other embodiments in which the first insulator layer 103 is formed using an implantation method, the material 105 of the first active layer 201 may initially be part of the first substrate 101 prior to the implantation process to form the first insulation layer 103. However, any suitable materials and methods of manufacture may be utilized to form the material 105 of the first active layer 201.

FIG. 2 illustrates that, once the material 105 for the first active layer 201 is ready, the first optical components 203 for the first active layer 201 are manufactured using the material 105 for the first active layer 201. In embodiments the first optical components 203 of the first active layer 201 may include such components as optical waveguides (e.g., ridge waveguides, rib waveguides, buried channel waveguides, diffused waveguides, etc.), couplers (e.g., grating couplers, edge couplers that are a narrowed waveguide with a width of between about 1 nm and about 200 nm, etc.), directional couplers, optical modulators (e.g., Mach-Zehnder silicon-photonic switches, microelectromechanical switches, micro-ring resonators, etc.), amplifiers, multiplexors, demultiplexors, optical-to-electrical converters (e.g., P-N junctions), electrical-to-optical converters, lasers, combinations of these, or the like. However, any suitable first optical components 203 may be used.

To begin forming the first active layer 201 of first optical components 203 from the initial material, the material 105 for the first active layer 201 may be patterned into the desired shapes for the first active layer 201 of first optical components 203. In an embodiment the material 105 for the first active layer 201 may be patterned using, e.g., one or more photolithographic masking and etching processes. However, any suitable method of patterning the material 105 for the first active layer 201 may be utilized. For some of the first optical components 203, such as waveguides or edge couplers, the patterning process may be all or at least most of the manufacturing that is used to form these first optical components 203 components.

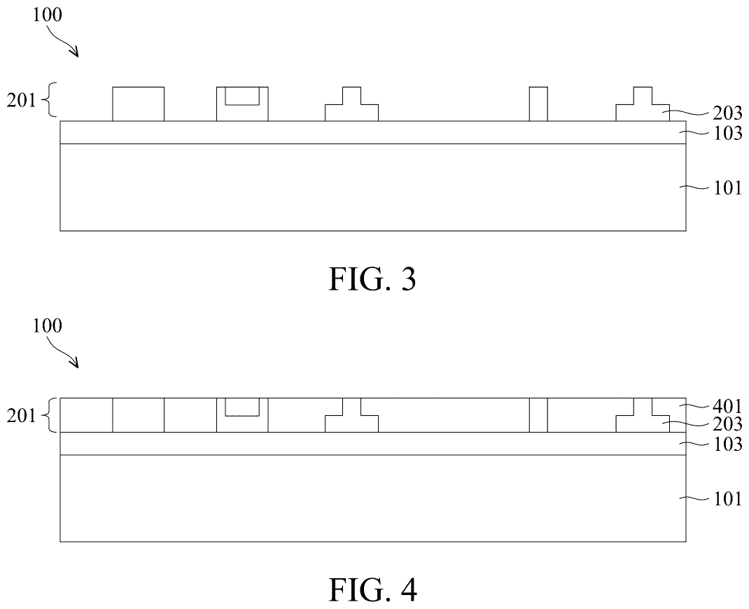

FIG. 3 illustrates that, for those components that utilize further manufacturing processes, such as Mach-Zehnder silicon-photonic switches that utilize resistive heating elements, additional processing may be performed either before or after the patterning of the material for the first active layer 201. For example, implantation processes, additional deposition and patterning processes for different materials (e.g., resistive heating elements, III-V materials for converters), combinations of all of these processes, or the like, can be utilized to help further the manufacturing of the various desired first optical components 203. In a particular embodiment, and as specifically illustrated in FIG. 3, in some embodiments an epitaxial deposition of a semiconductor material 301 such as germanium (used, e.g., for electricity/optics signal modulation and transversion) may be performed on a patterned portion of the material 105 of the first active layer 201. In such an embodiment the semiconductor material 301 may be epitaxially grown in order to help manufacture, e.g., a photodiode for an optical-to-electrical converter. All such manufacturing processes and all suitable first optical components 203 may be manufactured, and all such combinations are fully intended to be included within the scope of the embodiments.

FIG. 4 illustrates that, once the individual first optical components 203 of the first active layer 201 have been formed, a second insulator layer 401 may be deposited to cover the first optical components 203 and provide additional cladding material. In an embodiment the second insulator layer 401 may be a dielectric layer that separates the individual components of the first active layer 201 from each other and from the overlying structures and can additionally serve as another portion of cladding material that surrounds the first optical components 203. In an embodiment the second insulator layer 401 may be silicon oxide, silicon nitride, germanium oxide, germanium nitride, combinations of these, or the like, formed using a deposition method such as chemical vapor deposition, atomic layer deposition, physical vapor deposition, combinations of these, or the like. Once the material of the second insulator layer 401 has been deposited, the material may be planarized using, e.g., a chemical mechanical polishing process in order to either planarize a top surface of the second insulator layer 401 (in embodiments in which the second insulator layer 401 is intended to fully cover the first optical components 203) or else planarize the second insulator layer 401 with top surfaces of the first optical components 203. However, any suitable material and method of manufacture may be used.

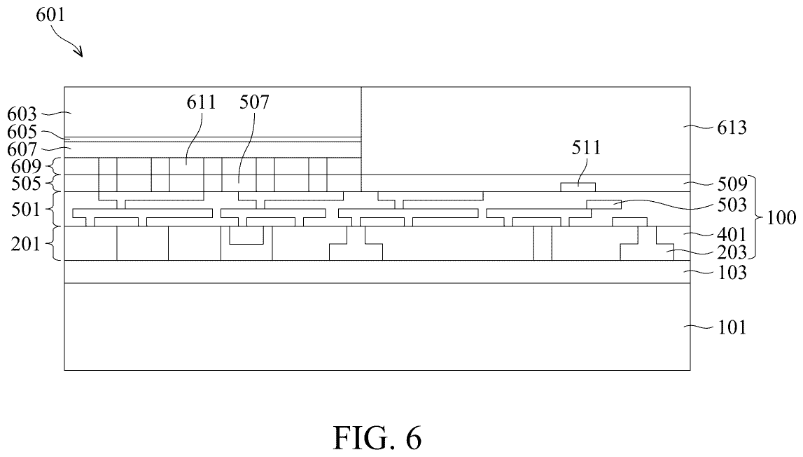

FIG. 5 illustrates that, once the first optical components 203 of the first active layer 201 have been manufactured and the second insulator layer 401 has been formed, first metallization layers 501 are formed in order to electrically connect the first active layer 201 of first optical components 203 to control circuitry, to each other, and to subsequently attached devices (not illustrated in FIG. 5 but illustrated and described further below with respect to FIG. 6). In an embodiment the first metallization layers 501 are formed of alternating layers of dielectric and conductive material and may be formed through any suitable processes (such as deposition, damascene, dual damascene, etc.). In particular embodiments there may be multiple layers of metallization used to interconnect the various first optical components 203, but the precise number of first metallization layers 501 is dependent upon the design of the optical interposer 100.

Additionally, during the manufacture of the first metallization layers 501, one or more second optical components 503 may be formed as part of the first metallization layers 501. In some embodiments the second optical components 503 of the first metallization layers 501 may include such components as couplers (e.g., edge couplers, grating couplers, etc.) for connection to outside signals, optical waveguides (e.g., ridge waveguides, rib waveguides, buried channel waveguides, diffused waveguides, etc.), optical modulators (e.g., Mach-Zehnder silicon-photonic switches, microelectromechanical switches, micro-ring resonators, etc.), amplifiers, multiplexors, demultiplexors, optical-to-electrical converters (e.g., P-N junctions), electrical-to-optical converters, lasers, combinations of these, or the like. However, any suitable optical components may be used for the one or more second optical components 503.

In an embodiment the one or more second optical components 503 may be formed by initially depositing a material for the one or more second optical components 503. In an embodiment the material for the one or more second optical components 503 may be a dielectric material such as silicon nitride, silicon oxide, combinations of these, or the like, or a semiconductor material such as silicon, deposited using a deposition method such as chemical vapor deposition, atomic layer deposition, physical vapor deposition, combinations of these, or the like. However, any suitable material and any suitable method of deposition may be utilized.

Once the material for the one or more second optical components 503 has been deposited or otherwise formed, the material may be patterned into the desired shapes for the one or more second optical components 503. In an embodiment the material of the one or more second optical components 503 may be patterned using, e.g., one or more photolithographic masking and etching processes. However, any suitable method of patterning the material for the one or more second optical components 503 may be utilized.

For some of the one or more second optical components 503, such as waveguides or edge couplers, the patterning process may be all or at least most of the manufacturing that is used to form these components. Additionally, for those components that utilize further manufacturing processes, such as Mach-Zehnder silicon-photonic switches that utilize resistive heating elements, additional processing may be performed either before or after the patterning of the material for the one or more second optical components 503. For example, implantation processes, additional deposition and patterning processes for different materials, combinations of all of these processes, or the like, and can be utilized to help further the manufacturing of the various desired one or more second optical components 503. All such manufacturing processes and all suitable one or more second optical components 503 may be manufactured, and all such combinations are fully intended to be included within the scope of the embodiments.

Once the one or more second optical components 503 of the first metallization layers 501 have been manufactured, a first bonding layer 505 is formed over the first metallization layers 501. In an embodiment, the first bonding layer 505 may be used for a dielectric-to-dielectric and metal-to-metal bond. In accordance with some embodiments, the first bonding layer 505 is formed of a first dielectric material 509 such as silicon oxide, silicon nitride, or the like. The first dielectric material 509 may be deposited using any suitable method, such as CVD, high-density plasma chemical vapor deposition (HDPCVD), PVD, atomic layer deposition (ALD), or the like. However, any suitable materials and deposition processes may be utilized.

Once the first dielectric material 509 has been formed, first openings in the first dielectric material 509 are formed to expose conductive portions of the underlying layers in preparation to form first bond pads 507 within the first bonding layer 505. Once the first openings have been formed within the first dielectric material 509, the first openings may be filled with a seed layer and a plate metal to form the first bond pads 507 within the first dielectric material 509. The seed layer may be blanket deposited over top surfaces of the first dielectric material 509 and the exposed conductive portions of the underlying layers and sidewalls of the openings and the second openings. The seed layer may comprise a copper layer. The seed layer may be deposited using processes such as sputtering, evaporation, or plasma-enhanced chemical vapor deposition (PECVD), or the like, depending upon the desired materials. The plate metal may be deposited over the seed layer through a plating process such as electrical or electro-less plating. The plate metal may comprise copper, a copper alloy, or the like. The plate metal may be a fill material. A barrier layer (not separately illustrated) may be blanket deposited over top surfaces of the first dielectric material 509 and sidewalls of the openings and the second openings before the seed layer. The barrier layer may comprise titanium, titanium nitride, tantalum, tantalum nitride, or the like.

Following the filling of the first openings, a planarization process, such as a CMP, is performed to remove excess portions of the seed layer and the plate metal, forming the first bond pads 507 within the first bonding layer 505. In some embodiments a bond pad via (not separately illustrated) may also be utilized to connect the first bond pads 507 with underlying conductive portions and, through the underlying conductive portions, connect the first bond pads 507 with the first metallization layers 501.

Additionally, the first bonding layer 505 may also include one or more third optical components 511 incorporated within the first bonding layer 505. In such an embodiment, prior to the deposition of the first dielectric material 509, the one or more third optical components 511 may be manufactured using similar methods and similar materials as the one or more second optical components 503 (described above), such as by being waveguides and other structures formed at least in part through a deposition and patterning process. However, any suitable structures, materials and any suitable methods of manufacture may be utilized.

FIG. 6 illustrates a bonding of a first semiconductor device 601 to the first bonding layer 505 of the optical interposer 100. In some embodiments, the first semiconductor device 601 is an electronic integrated circuit (EIC—e.g., a device without optical devices) and may have a semiconductor substrate 603, a layer of active devices 605, an overlying interconnect structure 607, a second bonding layer 609, and associated third bond pads 611. In an embodiment the semiconductor substrate 603 may be similar to the first substrate 101 (e.g., a semiconductor material such as silicon or silicon germanium), the active devices 605 may be transistors, capacitors, resistors, and the like formed over the semiconductor substrate 603, the interconnect structure 607 may be similar to the first metallization layers 501 (without optical components), the second bonding layer 609 may be similar to the first bonding layer 505, and the third bond pads 611 may be similar to the first bond pads 507. However, any suitable devices may be utilized.

In an embodiment the first semiconductor device 601 may be configured to work with the optical interposer 100 for a desired functionality. In some embodiments the first semiconductor device 601 may be a high bandwidth memory (HBM) module, an xPU, a logic die, a 3DIC die, a CPU, a GPU, a SoC die, a MEMS die, combinations of these, or the like. Any suitable device with any suitable functionality, may be used, and all such devices are fully intended to be included within the scope of the embodiments.

In an embodiment the first semiconductor device 601 and the first bonding layer 505 may be bonded using a dielectric-to-dielectric and metal-to-metal bonding process. In a particular embodiment which utilizes a dielectric-to-dielectric and metal-to-metal bonding process, the process may be initiated by activating the surfaces of the second bonding layer 609 and the surfaces of the first bonding layer 505. Activating the top surfaces of the first bonding layer 505 and the second bonding layer 609 may comprise a dry treatment, a wet treatment, a plasma treatment, exposure to an inert gas plasma, exposure to H₂, exposure to N₂, exposure to O₂, combinations thereof, or the like, as examples. In embodiments where a wet treatment is used, an RCA cleaning may be used, for example. In another embodiment, the activation process may comprise other types of treatments. The activation process assists in the bonding of the first bonding layer 505 and the second bonding layer 609.

After the activation process the optical interposer 100 and the first semiconductor device 601 may be cleaned using, e.g., a chemical rinse, and then the first semiconductor device 601 is aligned and placed into physical contact with the optical interposer 100. The optical interposer 100 and the first semiconductor device 601 are then subjected to thermal treatment and contact pressure to bond the optical interposer 100 and the laser die 600. For example, the optical interposer 100 and the first semiconductor device 601 may be subjected to a pressure of about 200 kPa or less, and a temperature between about 25° C. and about 250° C. to fuse the optical interposer 100 and the first semiconductor device 601. The optical interposer 100 and the first semiconductor device 601 may then be subjected to a temperature at or above the eutectic point for material of the first bond pads 507 and the third bond pads 611, e.g., between about 150° C. and about 650° C., to fuse the metal. In this manner, the optical interposer 100 and the first semiconductor device 601 forms a dielectric-to-dielectric and metal-to-metal bonded device. In some embodiments, the bonded dies are subsequently baked, annealed, pressed, or otherwise treated to strengthen or finalize the bond.

Additionally, while specific processes have been described to initiate and strengthen the bonds, these descriptions are intended to be illustrative and are not intended to be limiting upon the embodiments. Rather, any suitable combination of baking, annealing, pressing, or combination of processes may be utilized. All such processes are fully intended to be included within the scope of the embodiments.

FIG. 6 additionally illustrates that, once the first semiconductor device 601 has been bonded, a first gap-fill material 613 is deposited in order to fill the space around the first semiconductor device 601 and provide additional support. In an embodiment the first gap-fill material 613 may be a material such as silicon oxide, silicon nitride, silicon oxynitride, combinations of these, or the like, deposited to fill and overfill the spaces around the first semiconductor device 601. However, any suitable material and method of deposition may be utilized.

Once the first gap-fill material 613 has been deposited, the first gap-fill material 613 may be planarized in order to expose the first semiconductor device 601. In an embodiment the planarization process may be a chemical mechanical planarization process, a grinding process, or the like. However, any suitable planarization process may be utilized.

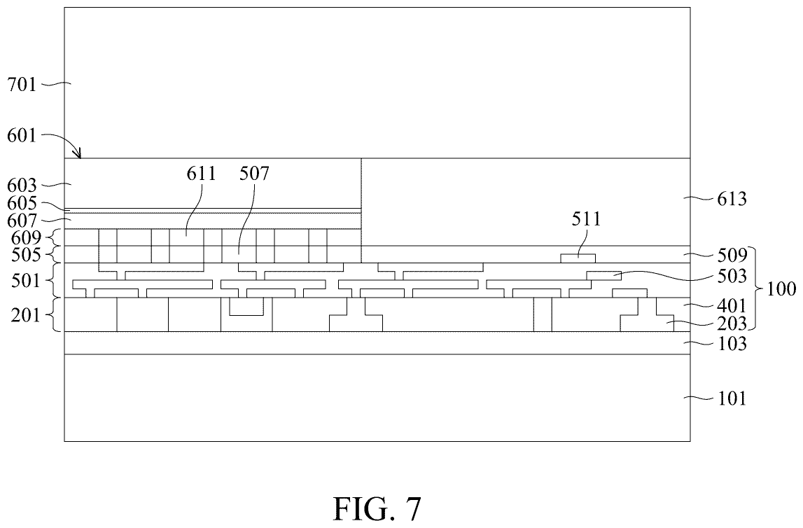

FIG. 7 illustrates an attachment of a first support substrate 701 to the first semiconductor device 601 and the first gap-fill material 613. In an embodiment the first support substrate 701 may be a support material that is transparent to the wavelength of light that is desired to be used, such as silicon, and may be attached using, e.g., an adhesive (not separately illustrated in FIG. 7). However, in other embodiments the first support substrate 701 may be bonded to the first semiconductor device 601 and the first gap-fill material 613 using, e.g., a bonding process. Any suitable method of attaching the first support substrate 701 may be used.

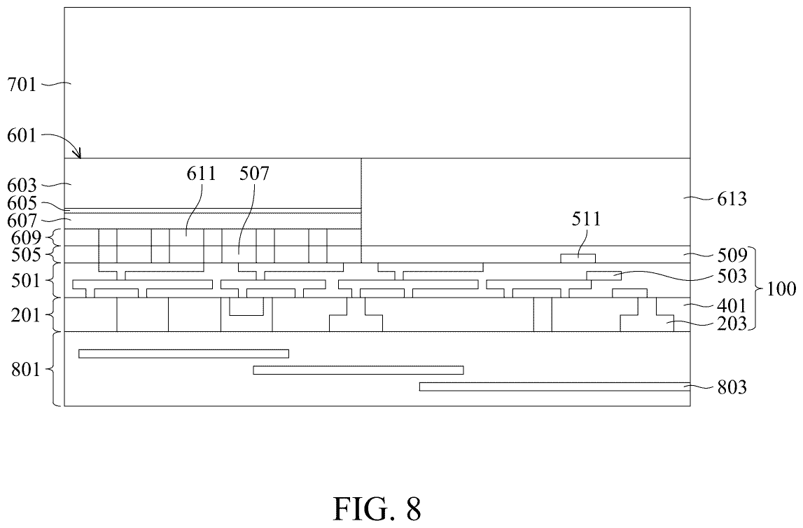

FIG. 8 illustrates a removal of the first substrate 101 and, optionally, the first insulator layer 103, thereby exposing the first active layer 201 of first optical components 203. In an embodiment the first substrate 101 and the first insulator layer 103 may be removed using a planarization process, such as a chemical mechanical polishing process, a grinding process, one or more etching processes, combinations of these, or the like. However, any suitable method may be used in order to remove the first substrate 101 and/or the first insulator layer 103.

Once the first substrate 101 and the first insulator layer 103 have been removed, a second active layer 801 of fourth optical components 803 may be formed on a back side of the first active layer 201. In an embodiment the second active layer 801 of fourth optical components 803 may be formed using similar materials and similar processes as the second optical components 503 of the first metallization layers 501 (described above with respect to FIG. 5). For example, the second active layer 801 of fourth optical components 803 may be formed of alternating layers of a cladding material such as silicon oxide and core material such as silicon nitride formed using deposition and patterning processes in order to form optical components such as waveguides and the like.

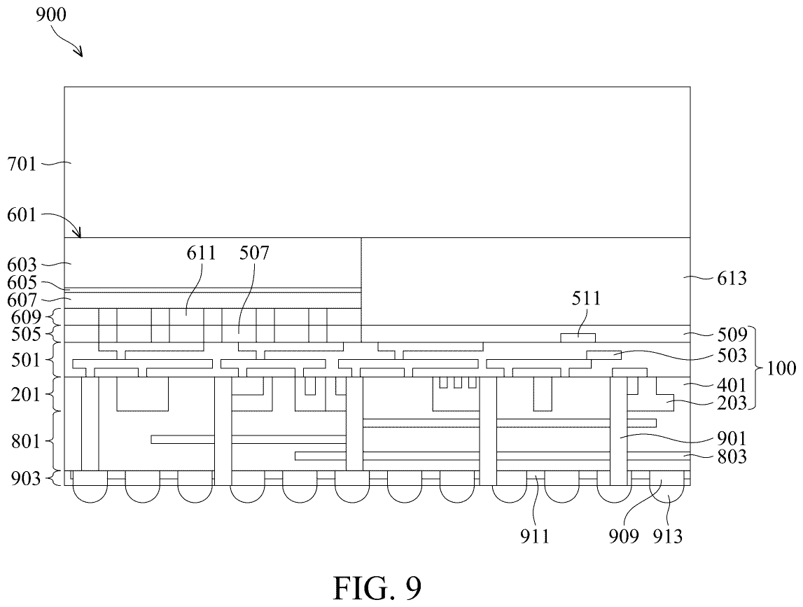

FIG. 9 illustrates formation of first through device vias (TDVs) 901 and formation of a third bonding layer 903 to form a first optical package 900 (e.g., an optical engine (OE)). In an embodiment the first through device vias 901 extend through the second active layer 801 and the first active layer 201 so as to provide a quick passage of power, data, and ground through the optical interposer 100. In an embodiment the first through device vias 901 may be formed by initially forming through device via openings into the optical interposer 100. The through device via openings may be formed by applying and developing a suitable photoresist (not shown), and removing portions of the second active layer 801 and the optical interposer 100 that are exposed.

Once the through device via openings have been formed within the optical interposer 100, the through device via openings may be lined with a liner. The liner may be, e.g., an oxide formed from tetraethylorthosilicate (TEOS) or silicon nitride, although any suitable dielectric material may alternatively be used. The liner may be formed using a plasma enhanced chemical vapor deposition (PECVD) process, although other suitable processes, such as physical vapor deposition or a thermal process, may also be used.

Once the liner has been formed along the sidewalls and bottom of the through device via openings, a barrier layer (also not independently illustrated) may be formed and the remainder of the through device via openings may be filled with first conductive material. The first conductive material may comprise copper, although other suitable materials such as aluminum, alloys, doped polysilicon, combinations thereof, and the like, may be utilized. The first conductive material may be formed by electroplating copper onto a seed layer (not shown), filling and overfilling the through device via openings. Once the through device via openings have been filled, excess liner, barrier layer, seed layer, and first conductive material outside of the through device via openings may be removed through a planarization process such as chemical mechanical polishing (CMP), although any suitable removal process may be used.

Optionally, in some embodiments once the first through device vias 901 have been formed, second metallization layers (not separately illustrated in FIG. 9) may be formed in electrical connection with the first through device vias 901. In an embodiment the second metallization layers may be formed as described above with respect to the first metallization layers 501, such as being alternating layers of dielectric and conductive materials using damascene processes, dual damascene process, or the like. In other embodiments, the second metallization layers may be formed using a plating process to form and shape conductive material, and then cover the conductive material with a dielectric material. However, any suitable structures and methods of manufacture may be utilized.

The third bonding layer 903 is formed in order to provide electrical connections between the optical interposer 100 and subsequently attached devices. In an embodiment the third bonding layer 903 may be similar to the first bonding layer 505, such as having third bond pads 909 (similar to the first bond pads 507) and even fifth optical components 911 (similar to the third optical components 511). However, any suitable devices may be utilized.

FIG. 9 additionally illustrates a placement of first external connectors 913 which may be formed to provide conductive regions for contact between the third bond pads 909 to other external devices. The first external connectors 913 may be conductive bumps (e.g., C4 bumps, ball grid arrays, microbumps, etc.) or conductive pillars utilizing materials such as solder and copper. In an embodiment in which the first external connectors 913 are contact bumps, the first external connectors 913 may comprise a material such as tin, or other suitable materials, such as silver, lead-free tin, or copper. In an embodiment in which the first external connectors 913 are tin solder bumps, the first external connectors 913 may be formed by initially forming a layer of tin through such commonly used methods such as evaporation, electroplating, printing, solder transfer, ball placement, etc. Once a layer of tin has been formed on the structure, a reflow may be performed in order to shape the material into the desired bump shape.

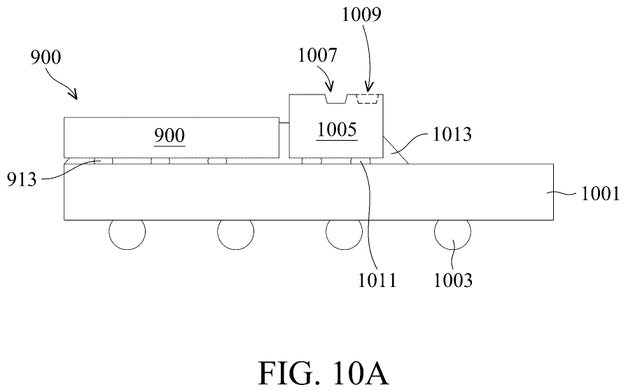

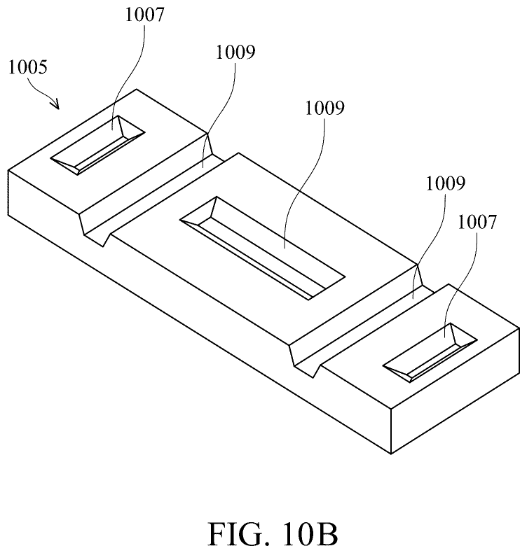

FIG. 10A illustrates that, once the first optical package 900 has been formed, the first optical package 900 may be attached to an interposer substrate 1001 and used to couple the first optical package 900 with other devices to form, for example, a chip-on-wafer-on-substrate (CoWos®) device. In an embodiment the interposer substrate 1001 comprises a semiconductor substrate, optional third metallization layers (not separately illustrated in FIG. 10A), second through device vias (TDVs), and second external connectors 1003. The semiconductor substrate may comprise bulk silicon, doped or undoped, or an active layer of a silicon-on-insulator (SOI) substrate. Generally, an SOI substrate comprises a layer of a semiconductor material such as silicon, germanium, silicon germanium, SOI, silicon germanium on insulator (SGOI), or combinations thereof. Other substrates that may be used include multi-layered substrates, gradient substrates, or hybrid orientation substrates.

Optionally, first active devices (not separately illustrated) may be added to the semiconductor substrate. The first active devices comprise a wide variety of active devices and passive devices such as capacitors, resistors, inductors and the like that may be used to generate the desired structural and functional requirements of the design for the semiconductor substrate. The first active devices may be formed using any suitable methods either within or else on the semiconductor substrate.

The third metallization layers are formed over the semiconductor substrate and the first active devices and are designed to connect the various devices to form functional circuitry. In an embodiment the third metallization layers are formed of alternating layers of dielectric (e.g., low-k dielectric materials, extremely low-k dielectric material, ultra low-k dielectric materials, combinations of these, or the like) and conductive material and may be formed through any suitable process (such as deposition, damascene, dual damascene, etc.). However, any suitable materials and processes may be utilized.

Additionally, if desired, the third metallization layers may further comprise interposer optical components (not separately illustrated) that can interact with the fifth optical components 911 of the first optical package 900. In an embodiment the interposer optical components can be formed using similar methods and materials as the third optical components 511 described above with respect to FIG. 5. However, any suitable methods and materials may be utilized.

Additionally, at any desired point in the manufacturing process, the second TDVs may be formed within the semiconductor substrate and, if desired, one or more layers of the third metallization layers, in order to provide electrical connectivity from a front side of the semiconductor substrate to a back side of the semiconductor substrate. In an embodiment the second TDVs may be formed by initially forming through device via (TDV) openings into the semiconductor substrate and, if desired, any of the overlying third metallization layers (e.g., after the desired third metallization layer has been formed but prior to formation of the next overlying third metallization layer). The TDV openings may be formed by applying and developing a suitable photoresist, and removing portions of the underlying materials that are exposed to a desired depth. The TDV openings may be formed so as to extend into the semiconductor substrate to a depth greater than the eventual desired height of the semiconductor substrate.

Once the TDV openings have been formed within the semiconductor substrate and/or any third metallization layers, the TDV openings may be lined with a liner. The liner may be, e.g., an oxide formed from tetraethylorthosilicate (TEOS) or silicon nitride, although any suitable dielectric material may be used. The liner may be formed using a plasma enhanced chemical vapor deposition (PECVD) process, although other suitable processes, such as physical vapor deposition or a thermal process, may be used.

Once the liner has been formed along the sidewalls and bottom of the TDV openings, a barrier layer may be formed and the remainder of the TDV openings may be filled with first conductive material. The first conductive material may comprise copper, although other suitable materials such as aluminum, alloys, doped polysilicon, combinations thereof, and the like, may be utilized. The first conductive material may be formed by electroplating copper onto a seed layer, filling and overfilling the TDV openings. Once the TDV openings have been filled, excess liner, barrier layer, seed layer, and first conductive material outside of the TDV openings may be removed through a planarization process such as chemical mechanical polishing (CMP), although any suitable removal process may be used.

Once the TDV openings have been filled, the semiconductor substrate may be thinned until the second TDVs have been exposed. In an embodiment the semiconductor substrate may be thinned using, e.g., a chemical mechanical polishing process, a grinding process, or the like. Further, once exposed, the second TDVs may be recessed using, e.g., one or more etching processes, such as a wet etch process in order to recess the semiconductor substrate so that the second TDVs extend out of the semiconductor substrate.

In an embodiment the second external connectors 1003 may be placed on the semiconductor substrate in electrical connection with the second TDVs and may be, e.g., a ball grid array (BGA) which comprises a eutectic material such as solder, although any suitable materials may be used. Optionally, an underbump metallization or additional metallization layers (not separately illustrated in FIG. 10A) may be utilized between the semiconductor substrate and the second external connectors 1003. In an embodiment in which the second external connectors 1003 are solder bumps, the second external connectors 1003 may be formed using a ball drop method, such as a direct ball drop process. In another embodiment, the solder bumps may be formed by initially forming a layer of tin through any suitable method such as evaporation, electroplating, printing, solder transfer, and then performing a reflow in order to shape the material into the desired bump shape. Once the second external connectors 1003 have been formed, a test may be performed to ensure that the structure is suitable for further processing.

Once the interposer substrate 1001 has been formed, the first optical package 900 may be attached to the interposer substrate 1001. In an embodiment the first optical package 900 may be attached to the interposer substrate 1001 by aligning the first external connectors 913 with conductive portions of the interposer substrate 1001. Once aligned and in physical contact, the first external connectors 913 are reflowed by raising the temperature of the first external connectors 913 past a eutectic point of the first external connectors 913, thereby shifting the material of the first external connectors 913 to a liquid phase. Once reflowed, the temperature is reduced in order to shift the material of the first external connectors 913 back to a solid phase, thereby bonding the first optical package 900 to the interposer substrate 1001. However, any suitable bonding process may be used to connect the first optical package to the interposer substrate 1001.

FIG. 10A additionally illustrates a placement of an alignment die 1005 on the interposer substrate 1001. In an embodiment the alignment die 1005 is a passive alignment die that is positioned so that subsequently attached components can be passively aligned with the first optical package 900. In an embodiment the alignment die 1005 may comprise one or more materials that can be shaped and provide structural support, such as silicon, silicon oxide, combinations of these, or the like. However, any suitable materials may be utilized.

The alignment die 1005 further comprises first alignment features 1007 and second alignment features 1009 (illustrated in the particular cross-section of FIG. 10A with a dashed outline to illustrate that the second alignment features 1009 are not seen in this particular cross-section). In an embodiment the first alignment features 1007 may be grooves, indentations, or other shapes, either indented into the material of the alignment die 1005 or extending away from the material of the alignment die 1005, that are intended to help provide a passive alignment when a receptacle 1200 is placed and attached to the alignment die 1005. The first alignment features 1007 may be formed using one or more photolithographic masking and etching processes, although any suitable methods may be utilized.

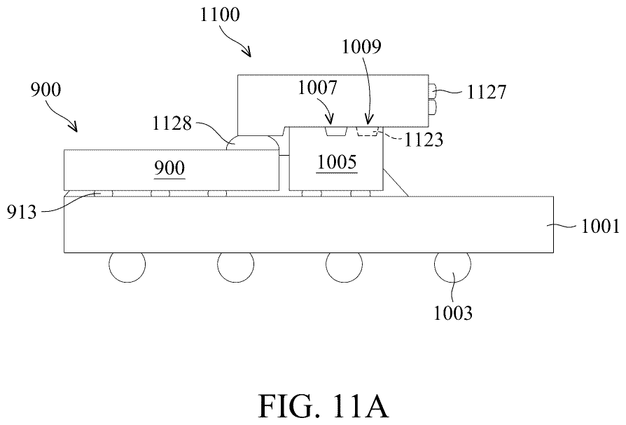

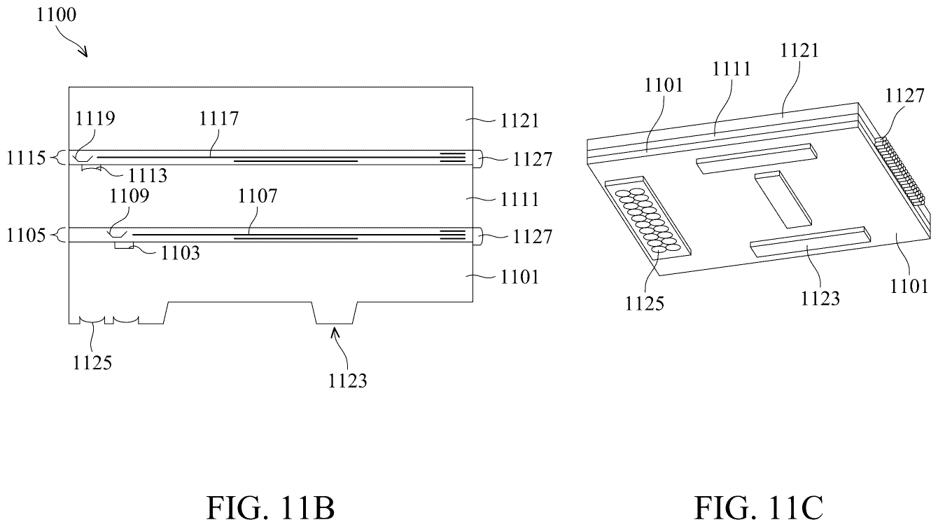

The second alignment features 1009 may be utilized in order to help provide alignment when a first optical passive device 1100 (not illustrated in FIG. 10A or 10B but illustrated below with respect to FIG. 11A). In an embodiment the second alignment features 1009 may be grooves, indentations, or other shapes, either indented into the material of the alignment die 1005 or extending away from the material of the alignment die 1005. The second alignment features 1009 may be formed simultaneously or sequentially with the first alignment features 1007, and may be formed using one or more photolithographic masking and etching processes. However, any suitable methods may be utilized.

FIG. 10B illustrates another view of the alignment die 1005. In this view there is illustrated the first alignment features 1007 and the second alignment features 1009 formed within the material of the alignment die 1005. In this embodiment the first alignment features 1007 and the second alignment features 1009 may comprise different shapes (e.g., slots, trenches, etc.) in different combinations. However, any suitable combination of materials and alignment features can be utilized.

Returning now to FIG. 10A, third external connections 1011 may be used to bond the alignment die 1005 to the interposer substrate 1001. In an embodiment the third external connections 1011 may be formed using similar materials and methods as the first external connectors 913, and the alignment die 1005 may be bonded to the interposer substrate 1001 using a process similar to the bonding process described above with respect to the first optical package 900. However, any suitable connections and any suitable bonding process may be utilized to bond the alignment die 1005 to the interposer substrate 1001.

Optionally, an underfill material 1013 may be placed. The underfill material 1013 may reduce stress and protect the joints resulting from the reflowing of the third external connections 1011 and the first external connectors 913. The underfill material 1013 may be formed by a capillary flow process after the first optical package 900 and the alignment die 1005 are attached.

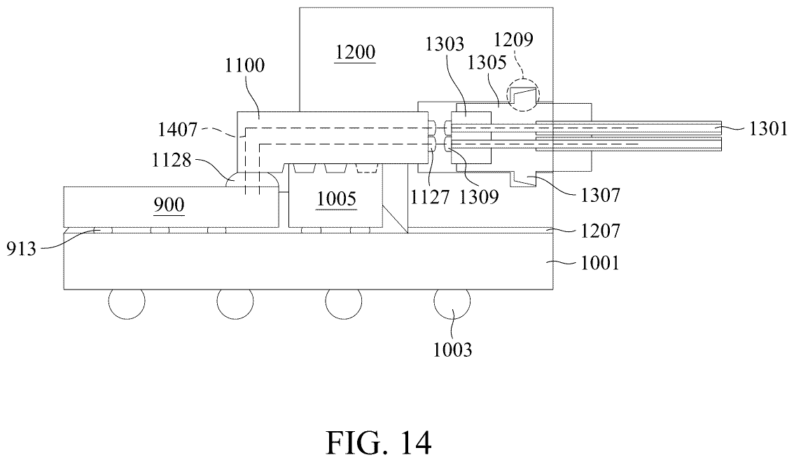

FIG. 11A illustrates a placement of the first optical passive device 1100 onto the alignment die 1005 such that in the illustrated cross-section the first optical passive device 1100 fully covers the alignment die 1005. In an embodiment the first optical passive device 1100 will be used to receive optical signals 1407 (not illustrated in FIG. 11A but illustrated below with respect to FIG. 14) from off of the device and route the optical signals 1407 to the first optical package 900. The first optical passive device 1100 will also be used to receive optical signals 1407 from the first optical package 900 and direct the optical signals 1407 off of the first optical package 900.

FIG. 11B illustrates one possible embodiment of the internals of the first optical passive device 1100. In a particular embodiment the first optical passive device 1100 may be formed using a first tier substrate 1101, a first lens 1103 formed within the first tier substrate 1101, and a first tier active layer 1105 with sixth optical components 1107 (including, e.g., an edge coupler). In an embodiment the first tier substrate 1101 may be similar to the first substrate 101 described above with respect to FIG. 1, such as by being a silicon substrate. However, any suitable material may be utilized.

The first lens 1103 is formed within the first tier substrate 1101. In an embodiment the first lens 1103 may be formed by shaping the material of the support substrate (e.g., silicon) using masking and etching processes. However, any suitable process may be utilized.

Additionally, if desired, a first anti-reflective coating (ARC) may be formed on the first lens 1103. In an embodiment the first ARC may be one or more layers of materials which help to prevent undesired reflections as light is focused through the first lens 1103. In a particular embodiment the one or more layers of materials may be materials such as silicon oxide, silicon nitride, combinations of these, or the like, formed using processes such as chemical vapor deposition, atomic layer deposition, physical vapor deposition, oxidation, nitridation, combinations of these, or the like.

In a particular embodiment the first ARC may be formed using a first layer of silicon oxide and a first layer of silicon nitride formed over the first layer of silicon oxide. A second layer of silicon oxide and a second layer of silicon nitride are deposited over the first layer of silicon oxide and the first layer of silicon nitride, forming an alternating stack of silicon oxide and silicon nitride. Once all of the desired layers have been deposited, the layers may be patterned using, e.g., a photolithographic masking and etching process. However, any suitable combinations of materials and processes may be utilized.

Additionally, if the recess formed by the first lens 1103 is not otherwise filled, a fill material may be deposited in order to fill the recess formed by the first lens 1103. In an embodiment the fill material may be a cladding material such as silicon oxide deposited using a method such as chemical vapor deposition, physical vapor deposition, atomic layer deposition, combinations of these, or the like. Once the recess has been filled, the fill material may be planarized using a process such as chemical mechanical polishing in order to remove portions of the fill material outside of the recess.

Once the first lens 1103 has been formed, a first tier active layer 1105 with sixth optical components 1107 is formed over the first tier substrate 1101. In an embodiment the first tier active layer 1105 with sixth optical components 1107 may be formed using similar materials and similar processes as the second active layer 801 of the fourth optical components 803 described above with respect to FIG. 8. However, any suitable materials and processes may be utilized.

In a particular embodiment the sixth optical components 1107 comprise at least one integrated multiple coupler (IMC) (e.g., an edge coupler), such as a multiple waveguide edge coupler that is situated to receive the optical signals 1407. However, any suitable optical components may be formed.

Once the first tier active layer 1105 with sixth optical components 1107 has been formed, the first mirror 1109 may be formed to extend into the first tier active layer 1105. In an embodiment the first mirror 1109 may be formed by initially patterning the first tier active layer 1105 to form a recess. In an embodiment the recess may be formed using one or more photolithographic masking and etching processes, such as one or more wet etching processes or dry etching processes. However, any suitable process may be utilized.

Once the recess has been formed, the first mirror 1109 may be formed along sidewalls of the recess. In an embodiment the first mirror 1109 may be a single layer of a reflective material such as aluminum copper, copper, gold, aluminum, titanium nitride, combinations of these, or the like, or else may be a multi-layer structure such as a Braggs reflector comprising alternating layers of different materials, such as alternating layers of silicon dioxide and amorphous silicon. The individual materials of the first mirror 1109 may be deposited using any suitable methods, such as chemical vapor deposition, physical vapor deposition, plating, combinations of these, or the like, and the individual layers may be then be further patterned using, e.g., a photolithographic masking and etching process (for example, to remove horizontal portions of the deposited materials). However, any suitable materials and methods may be utilized in order to form the first mirror 1109 along the sidewalls of the recess.

Additionally, if the formation of the first mirror 1109 does not fully fill the recess, the recess may be filled and planarized. In an embodiment the recess may be filled and/or overfilled with a material similar to the cladding material of the first tier active layer 1105 deposited using a method such as chemical vapor deposition, followed by a planarization process such as a chemical mechanical polishing process. However, any suitable material and any suitable process may be utilized.

Once the first mirror 1109 has been formed, the first tier active layer 1105 may be bonded to a second tier substrate 1111. In an embodiment the second tier substrate 1111 may be similar to the first tier substrate 1101, such as by being a material such as glass or silicon, and the second tier substrate 1111 may be bonded to the first tier active layer 1105 using, for example, a dielectric-to-dielectric bonding process. However, any suitable materials and any suitable bonding process may be utilized.

FIG. 11B additionally illustrates formation of a second lens 1113 on an opposite side of the second tier substrate 1111 from the first lens 1103. In an embodiment the second lens 1113 may be formed using similar processes as the first lens 1103 described above and, if desired, a second ARC may be formed using similar processes as the first ARC. However, any suitable processes may be utilized.

A second tier active layer 1115 with seventh optical components 1117 may be formed over the second lens 1113. In an embodiment the second tier active layer 1115 and the seventh optical components 1117 may be formed using similar materials and methods as the first tier active layer 1105 with the sixth optical components 1107 described above. In a particular embodiment the sixth optical components 1107 may be separated from the seventh optical components 1117 by a distance of about 250 μm. However, any suitable distance may be utilized.

FIG. 11B additionally illustrates a formation of a second mirror 1119. In an embodiment the second mirror 1119 may be formed using similar processes and materials as the first mirror 1109, described above. However, any suitable process and materials may be utilized.

Once the second mirror 1119 has been formed, the second tier active layer 1115 may be bonded to a third tier substrate 1121. In an embodiment the third tier substrate 1121 may be similar to the first tier substrate 1101, such as by being a material such as glass or silicon, and the third tier substrate 1121 may be bonded to the second tier active layer 1115 using, for example, a dielectric-to-dielectric bonding process. However, any suitable materials and any suitable bonding process may be utilized.

FIG. 11B additionally illustrates formation of third alignment features 1123 and third lenses 1125 on a side of the first tier substrate 1101 opposite from the first tier active layer 1105. In an embodiment the third lenses 1125 may be formed using similar processes as the first lens 1103 or the second lens 1113 (along with respective ARC layers and fill materials), described above. However, any suitable process may be utilized.

The third alignment features 1123 are utilized in order to help passively align the first optical passive device 1100 when the first optical passive device 1100 is attached to the alignment die 1005 and the first optical package 900. In an embodiment the third alignment features 1123 may be formed in a complementary pattern to the second alignment features 1009 and may be formed using similar processes as the first alignment features 1007 and the second alignment features 1009, such as by using a photolithographic masking and etching process to form protrusions from the first tier substrate 1101 for the third alignment features 1123 in the material of the first tier substrate 1101. However, any suitable method may be utilized.

Fourth lenses 1127 may be formed or placed adjacent to the first tier active layer 1105 and the second tier active layer 1115 in order to help receive and transmit the optical signals 1407. In an embodiment the fourth lenses 1127 may be formed separately from the first tier active layer 1105 and the second tier active layer 1115 and then attached, or else may be formed as part of the first tier active layer 1105 and the second tier active layer 1115. Any suitable method of forming and/or placing the fourth lenses 1127 may be utilized.

FIG. 11C illustrates a three dimensional view of the first optical passive device 1100. In this figure can be seen the bottom side of the first tier substrate 1101 with the third alignment features 1123 and the fourth lenses 1127. However, any suitable structures may be present on the backside of the first optical passive device 1100.

Returning now to FIG. 11A, the first optical passive device 1100 may be attached to both the alignment die 1005 and the first optical package 900. In an embodiment the first optical passive device 1100 may be attached to the alignment die 1005 by first aligning the third alignment features 1123 (on the first optical passive device 1100) with the second alignment features 1009 (of the alignment die 1005) and then inserting the third alignment features 1123 with the second alignment features 1009 so that the second alignment features 1009 are conjoined with the third alignment features 1123. Optionally, if desired an adhesive (not separately illustrated) may be utilized for a better connection.

Additionally, the alignment of the first optical passive device 1100 will additionally align the third lenses 1125 with receiving structures (e.g., grating couplers) within the first optical package 900. If desired, an optical glue 1128 may be utilized to adhere the first optical passive device 1100 with the first optical package 900. In some embodiments, the optical glue 1128 comprises a polymer material such as epoxy-acrylate oligomers, and may have a refractive index between about 1 and about 3. However, any suitable material may be utilized.

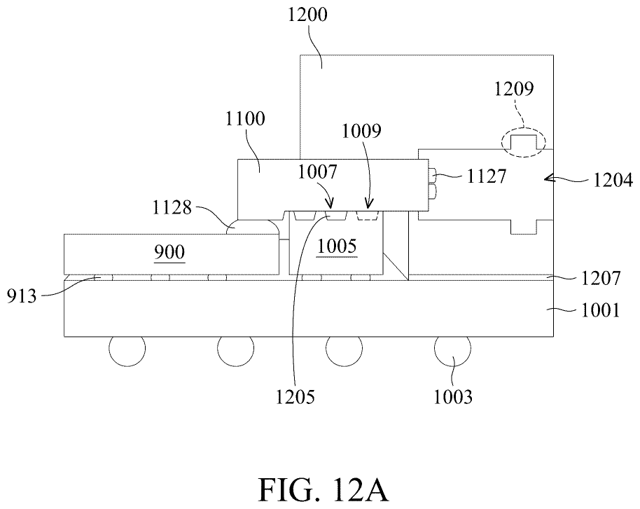

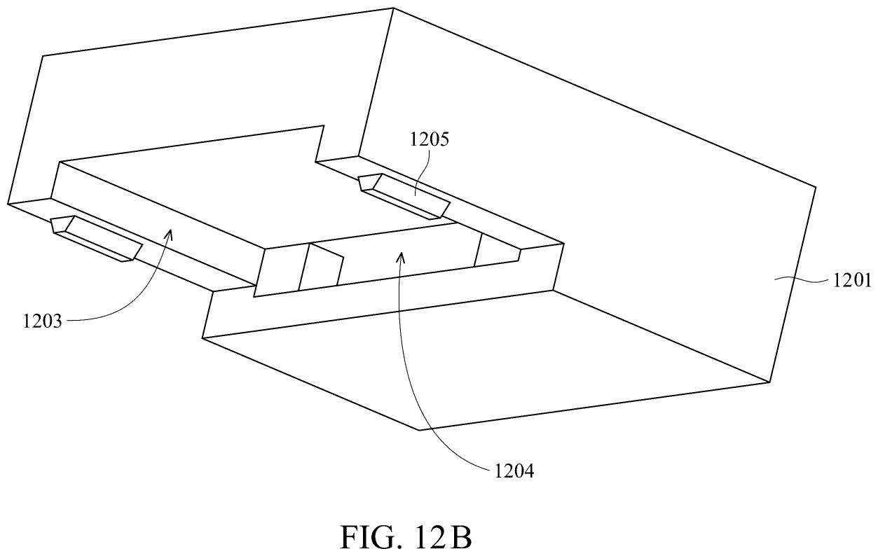

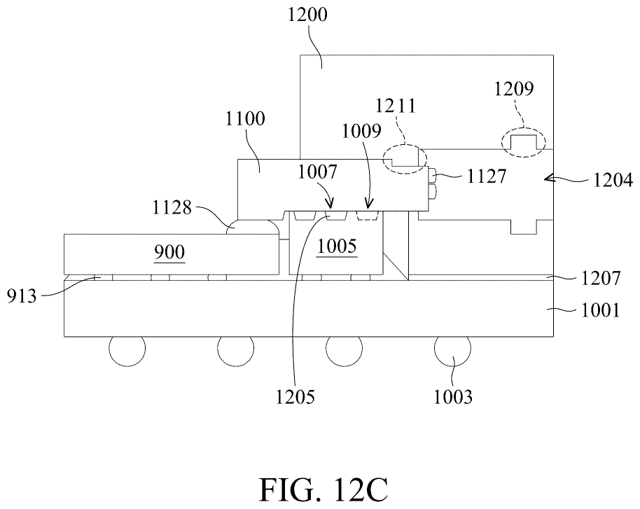

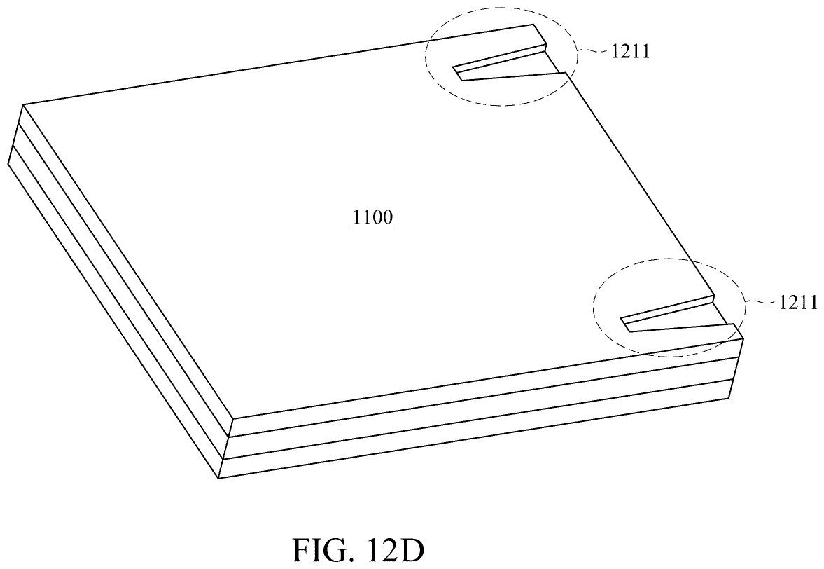

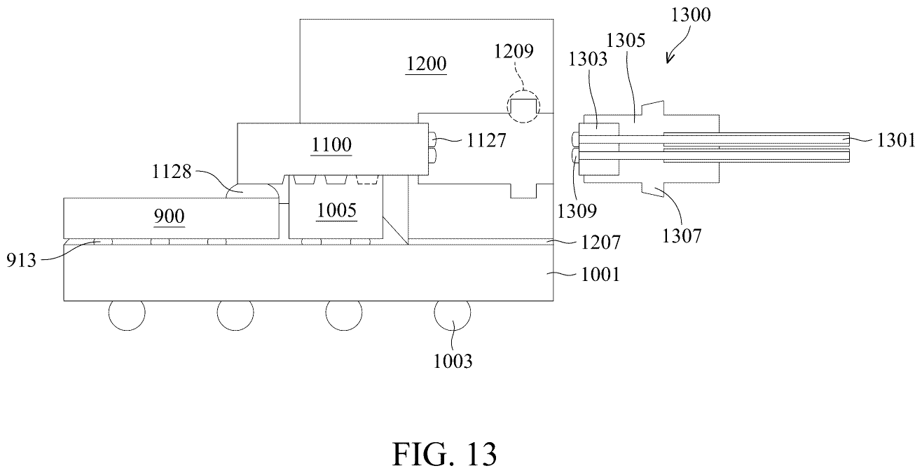

FIG. 12A illustrates an attachment of the receptacle 1200 to both the first optical passive device 1100 and the interposer substrate 1001. In an embodiment the receptacle 1200 is utilized to align and hold a detachable fiber array unit 1300 (FAU-not separately illustrated in FIG. 12A but illustrated and described below with respect to FIG. 13).

FIG. 12B illustrates a three dimensional view of the receptacle 1200 and illustrates a receptacle material 1201, a first opening 1203 for the first optical passive device 1100, a second opening 1204 for the subsequently attached FAU 1300, and fourth alignment features 1205. In an embodiment the receptacle material 1201 may be a material similar to the alignment die 1005, such as by being PPS, ABS, PEEK, ceramics, metals, combinations of these, or the like, formed using a process such as compression molding or photolithographic masking and etching processes. However, any suitable material and method of manufacture may be utilized.

The first opening 1203 and the second opening 1204 may be hollow locations located within the receptacle material 1201 in order to accommodate both the first optical passive device 1100 as well as the FAU 1300. Additionally, the second opening 1204 may additionally comprise first extensions 1209 in order to receive connection structures 1307 from the FAU 1300 in order to hold the FAU 1300 in place. The first opening 1203 and the second opening 1204 may be formed during manufacture of the receptacle 1200, such as by being formed during a molding process, or else may be formed using one or more photolithographic masking and etching process. Any suitable methods and processes may be utilized to form the first opening 1203.

The receptacle 1200 additionally comprises the fourth alignment features 1205 in order to help assist in the alignment and placement of the receptacle 1200 onto the alignment die 1005. In an embodiment the fourth alignment features 1205 may be formed in a complementary pattern to the first alignment features 1007. In an embodiment in which the receptacle 1200 is molded, the fourth alignment features 1205 may be formed simultaneously with the rest of the receptacle 1200. However, any suitable method may be utilized.

Returning to FIG. 12A, once the receptacle 1200 has been formed, the receptacle 1200 may be placed around the first optical passive device 1100 and on the alignment die 1005. In a particular embodiment the receptacle 1200 may be aligned such that the first optical passive device 1100 is located within the first opening 1203. Additionally, the fourth alignment features 1205 may be placed into the first alignment features 1007 of the alignment die 1005. Optionally, if desired an adhesive (not separately illustrated) may be utilized for a better connection with the alignment die 1005, and an adhesive 1207 may be utilized to provide for a better connection with the interposer substrate 1001.

FIGS. 12C-12D illustrate another embodiment of the placement of the receptacle 1200 onto the first optical passive device 1100, wherein the receptacle 1200 is aligned with the first optical passive device 1100 as well as the alignment die 1005. In this embodiment the receptacle 1200 has a first receptacle alignment feature 1211 and the first optical passive device 1100 has a second receptacle alignment feature 1213 that corresponds to the first receptacle alignment feature 1211. During placement of the receptacle 1200 in this embodiment, the first receptacle alignment feature 1211 of the receptacle 1200 is inserted and conjoined with the second receptacle alignment feature 1213 of the first optical passive device 1100, in addition to or in place of the other alignments described above.

FIG. 13 illustrates a detachable fiber array unit (FAU) 1300 that is utilized to connect and align one or more optical fibers 1301 with the first optical passive device 1100 without the use of an optical glue on the FAU 1300. In an embodiment each of the one or more optical fibers 1301 may comprise a core material such as glass surrounded by one or more cladding materials. Optionally, a surrounding cover material may be used to surround the outer cladding material in order to provide additional protection.

To align the optical fibers 1301, the FAU 1300 comprises a ferrule 1303, a ferrule housing 1305, and one or more connection structures 1307. Looking first at the ferrule 1303, the ferrule 1303 may be used to receive the plurality of optical fibers 1301, align the optical fibers 1301, and connect the optical fibers 1301. In an embodiment, the ferrule 1303 may be a mechanical transfer (MT) ferrule or a multi-fiber push on (MPO) ferrule and the like made of a material that can be used to protect, support and align the individual optical fibers 1301. However, any suitable materials may be utilized. In an embodiment, the optical fibers 1301 may be inserted into openings located within the ferrule 1303. Once inserted a glue material, such as an epoxy, silicone, a photocurable elastic polymer, combinations of these, or the like, may be injected or otherwise placed into the openings within the ferrule 1303 in order to secure the optical fibers 1301 within the ferrule 1303. Additionally, a curing process such as a light cure, a heat cure, or the like, may be utilized to harden the glue material, and the optical fibers 1301 may be polished and cleaned in order to prepare the optical fibers 1301 within the ferrule 1303 for optical connection. In this embodiment, the ferrule 1303 helps secure the optical fibers 1301 such that the optical signal 1407 provided by the optical fibers 1301 may be transmitted to the first optical package 900.

The ferrule housing 1305 may be attached to the ferrule 1303 and helps align the optical fibers 1301. In an embodiment the ferrule housing 1305 works to hold and house the ferrule 1303 and may be formed of a molded material. However, any suitable material and any method of formation may be utilized.

Additionally, the ferrule housing 1305 comprises the connection structures 1307 that are used to help hold the ferrule 1303 once the ferrule 1303 is inserted into the receptacle 1200 by inserting the connection structures 1307 into the first extensions 1209 of the second opening 1204. In an embodiment the connection structures 1307 may be a latching spring which allows for a releasable engagement with the receptacle 1200. However, any suitable structures may be utilized.

The FAU 1300 optionally comprises fifth lenses 1309. In an embodiment the fifth lenses 1309 may be formed and/or placed using similar materials and processes as the fourth lenses 1127. However, any suitable methods and materials may be utilized.

FIG. 14 illustrates an insertion of the ferrule 1303 into the receptacle 1200. In an embodiment the ferrule 1303 is inserted until the connection structures 1307 snap into place within the first extensions 1209 of the receptacle 1200. By inserting the ferrule 1303 into the receptacle the ferrule 1303 and the receptacle 1200 work to align the optical fibers 1301 with the first optical passive device 1100. In particular embodiments the insertion may be continued until the fourth lenses 1127 and the fifth lenses 1309 are between about 50 μm and about 1 mm. However, any suitable distance may be utilized.

FIG. 14 additionally illustrates a transmission of optical signals (represented in FIG. 14 by the dashed lines labeled 1407) between the optical fibers 1301 and the first optical package 900. In an embodiment the optical signals 1407 may leave the optical fibers 1301 and enter the first optical passive device 1100. The first optical passive device 1100 receives the optical signals 1407 using, e.g., the sixth optical components 1107 and the seventh optical components 1117, which directs the optical signals 1407 to the first mirror 1109 and the second mirror 1119. The first mirror 1109 and the second mirror 1119 redirect the optical signals 1407 to the first lens 1103, the second lens 1113, and the third lenses 1125, which modulate the optical signals 1407 prior to the optical signals 1407 entering the first optical package 900. The optical signals 1407 may then be received into the first optical package 900 using, e.g., a grating coupler within any of the first optical components 203, the second optical components 503, the third optical components 511, the fourth optical components 803, or the fifth optical components 911, before being routed around the first optical package 900.

Additionally, the use of the fourth lenses 1127 and the fifth lenses 1309 allows for a larger tolerance for alignment. In particular, the fourth lenses 1127 and the fifth lenses 1309 can be used to form a collimating beam from the optical signals 1407 with a larger beam size. With the larger beam, the alignment tolerance between the FAU 1300 and the first optical passive device 1100 can be increased, thereby allowing for passive alignment to be used.

Similarly, during a transmission of the optical signal 1407 out of the first optical package 900, the first optical package 900 will route the optical signals 1407 towards the first optical passive device 1100, which receives the optical signals 1407 and routes the optical signals 1407 to the optical fibers 1301. However, any suitable path may be utilized.

By utilizing the alignment die 1005 and its alignment features as described above, the first optical passive device 1100 can be accurately positioned on the alignment die 1005 and passively aligned with the first optical package 900 through the alignment die 1005. Further, the receptacle 1200 can also be accurately positioned on the alignment die 1005, and the detachable FAU 1300, once it has been inserted into the receptacle 1200, can be passively aligned with the first optical package 900 through the passive alignment die without the use of glue being applied to the FAU 1300. Additionally, because the FAU 1300 is detachable and not fixed to the first optical package 900, the assembly time can be reduced, thereby improving the overall yield of the process.

Additionally, if desired, the FAU 1300 may also be removed from the receptacle 1200 easily and without the use of harsh and time consuming processes such as removing an adhesive. In some embodiments the FAU 1300 may be removed by pushing and/or rotating the FAU 1300 through either mechanical design or tools to release the FAU 1300 from the receptacle 1200. However, any suitable method or design may be utilized.

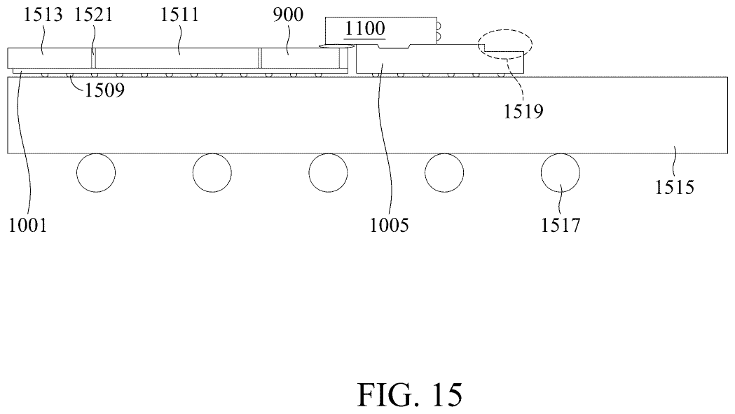

FIG. 15 illustrates another embodiment in which the alignment die 1005 is utilized to help align the FAU 1300 along with the first optical passive device 1100. In the embodiment illustrated, the first optical package 900 is bonded to the interposer substrate 1001 and used to couple the first optical package 900 with other devices to form, for example, a chip-on-wafer-on-substrate (CoWoS®) device. In this embodiment, however, a second semiconductor device 1511 and a third semiconductor device 1513 are also bonded onto the interposer substrate 1001. In some embodiments, the second semiconductor device 1511 is an electronic integrated circuit (EIC) such as a stacked device that includes multiple, interconnected semiconductor substrates. For example, the second semiconductor device 1511 may be a memory device such as a high bandwidth memory (HBM) module, a hybrid memory cube (HMC) module, or the like that includes multiple stacked memory dies. In such embodiments, the second semiconductor device 1511 includes multiple semiconductor substrates interconnected by third through device vias (TDVs). Each of the semiconductor substrates may (or may not) have a layer of active devices and an overlying interconnect structure, a bond layer, and associated bond pads in order to interconnect the multiple devices within the second semiconductor device 1511.

Of course, while the second semiconductor device 1511 is a HBM module in one embodiment, the embodiments are not restricted to the second semiconductor device 1511 being an HBM module. Rather, the second semiconductor device 1511 may be any suitable semiconductor device, such as a processor die or other type of functional die. In particular embodiments the second semiconductor device 1511 may be an xPU, a logic die, a 3DIC die, a CPU, a GPU, a SoC die, a MEMS die, combinations of these, or the like. Any suitable device with any suitable functionality, may be used, and all such devices are fully intended to be included within the scope of the embodiments.

The third semiconductor device 1513 may be another EIC that is intended to work with both the first optical package 900 and the second semiconductor device 1511. In some embodiments the third semiconductor device 1513 may have a different functionality from the second semiconductor device 1511, such as by being an xPU, a GPU, an ASIC device, or may have a same functionality as the second semiconductor device 1511, such as by being another high bandwidth memory device.

In an embodiment both the second semiconductor device 1511 and the third semiconductor device 1513 may be bonded to the interposer substrate 1001 using, e.g., fourth external connections (not separately illustrated in FIG. 15). The fourth external connections may be conductive bumps (e.g., ball grid arrays, microbumps, etc.) or conductive pillars utilizing materials such as solder and copper. In an embodiment in which the fourth external connections are contact bumps, the fourth external connections may comprise a material such as tin, or other suitable materials, such as silver, lead-free tin, or copper. In an embodiment in which the fourth external connections are tin solder bumps, the fourth external connections may be formed by initially forming a layer of tin through such commonly used methods such as evaporation, electroplating, printing, solder transfer, ball placement, etc. Once a layer of tin has been formed on the structure, a reflow may be performed in order to shape the material into the desired bump shape.

Additionally, once the fourth external connections have been placed, the second semiconductor device 1511 and the third semiconductor device 1513 are aligned with the interposer substrate 1001. Once aligned and in physical contact, the fourth external connections are reflowed by raising the temperature of the fourth external connections past a eutectic point of the fourth external connections, thereby shifting the material of the fourth external connections to a liquid phase. Once reflowed, the temperature is reduced in order to shift the material of the fourth external connections back to a solid phase, thereby bonding the second semiconductor device 1511 and the third semiconductor device 1513 to the interposer substrate 1001.

Optionally, an underfill material (not separately illustrated) may be placed. The underfill material may reduce stress and protect the joints resulting from the reflowing of the fourth external connections and the first external connectors 913. The underfill material may be formed by a capillary flow process after the first optical package 900, the second semiconductor device 1511 and the third semiconductor device 1513 are attached. Further, the first optical package 900, the second semiconductor device 1511 and the third semiconductor device 1513 may be encapsulated with an encapsulant 1521 using, e.g., a molding process.

Once the second semiconductor device 1511, the third semiconductor device 1513 and the first optical package 900 have been bonded to the interposer substrate 1001, the interposer substrate 1001 may be bonded to a package substrate 1515 with, e.g., the fifth external connectors 1509. In an embodiment the package substrate 1515 may be a printed circuit board (PCB) or the like. The package substrate 1515 may include one or more dielectric layers and electrically conductive features, such as conductive lines and vias. In some embodiments, the package substrate 1515 may include through-vias, active devices, passive devices, and the like. The package substrate 1515 may further include conductive pads formed at the upper and lower surfaces of the package substrate 1515.

During the bonding process the fifth external connectors 1509 may be aligned with corresponding conductive connections on the package substrate 1515. Once aligned the fifth external connectors 1509 may then be reflowed in order to bond the package substrate 1515 to the interposer substrate 1001. However, any suitable bonding process may be used to connect the interposer substrate 1001 to the package substrate 1515.

Additionally, the package substrate 1515 may be prepared for further connections by placing sixth external connections 1517 on an opposite side of the package substrate 1515 from the first optical package 900. In an embodiment the sixth external connections 1517 may be formed using similar processes and materials as the fifth external connectors 1509. However, any suitable materials and processes may be utilized.

FIG. 15 additionally illustrates a placement of the alignment die 1005 on the package substrate 1515 adjacent to the first optical package 900. In an embodiment the alignment die 1005 may be placed and bonded as described above with respect to FIG. 10A. However, any suitable method may be utilized.

However, in this embodiment the alignment die 1005 is shaped in order to be able to receive and align not only the first optical passive device 1100 and the receptacle 1200, but to also help receive and align the ferrule 1303. As such, the alignment die 1005 will additionally have fifth alignment features 1519 (formed using similar processes as the first alignment features 1007) that will receive and help further align the ferrule 1303. However, any suitable features may be utilized.

FIG. 15 additionally illustrates a placement and attachment of the first optical passive device 1100 onto both the first optical package 900 and the alignment die 1005. In an embodiment the first optical passive device 1100 may be placed and aligned as described above with respect to FIG. 11A, although in this embodiment, in order to make room for the connection of the ferrule 1303, after the first optical passive device 1100 has been placed the alignment die 1005 has a portion that extends beyond the first optical passive device 1100. However, any suitable placement and connecting process may be used.

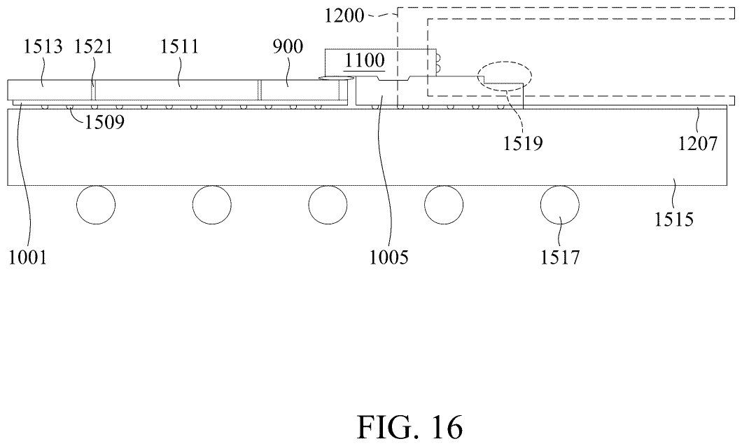

FIG. 16 illustrates placement of the receptacle 1200 (with the receptacle 1200 being illustrated in simplified form). In an embodiment the receptacle 1200 may be placed as described above with respect to FIG. 12A. However, in other embodiments the receptacle 1200 may be placed without alignment (e.g., without the use of the fourth alignment features 1205) and are instead simply held in place with the use of the adhesive 1207. In this embodiment the second alignment features 1009 are not used and maybe not even formed in the alignment die 1005. However, any suitable method may be utilized.

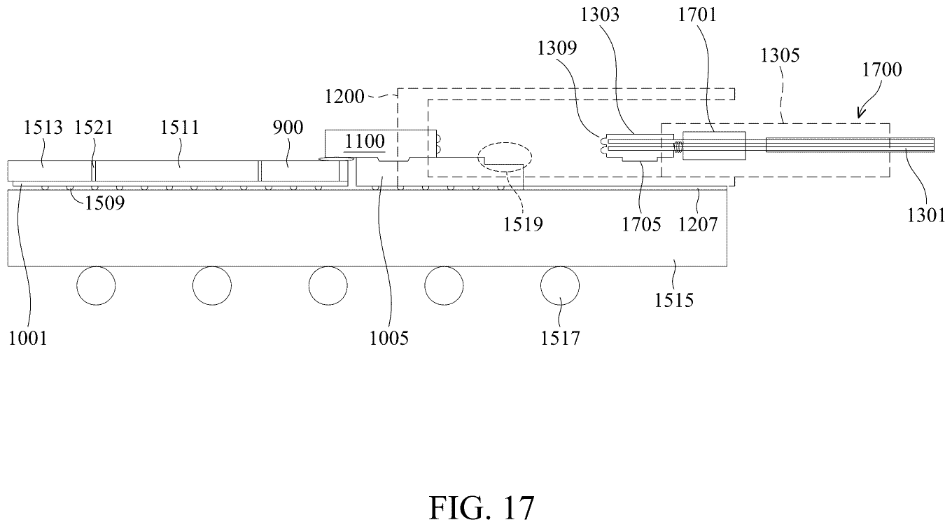

FIG. 17 illustrates a second FAU 1700 which may be used in this embodiment. In this embodiment the second FAU 1700 comprises the ferrule 1303 which aligns the optical fibers 1301, the ferrule housing 1305, and the connection structures 1307, but also comprises a spring push 1701.

However, in this embodiment the ferrule 1303 itself comprises a sixth alignment feature 1705. In an embodiment the sixth alignment feature 1705 is complementary to the fifth alignment features 1519 of the alignment die 1005 and is used to provide a more fine alignment between the ferrule 1303 and the first optical passive device 1100. However, any suitable size or shape may be utilized.

Additionally in this embodiment, to help ensure a better alignment, in this embodiment a spring push 1701 is utilized to apply a small force to the ferrule 1303 after the ferrule 1303 is inserted into the receptacle 1200. In particular, the small force applied by the spring push 1701 pushes the sixth alignment feature 1705 of the ferrule 1303 into the fifth alignment feature 1519 of the alignment die 1005 such that the ferrule 1303 comes into a finer alignment with the first optical passive device 1100. However, any suitable methods or structures may be utilized to provide a finer alignment.

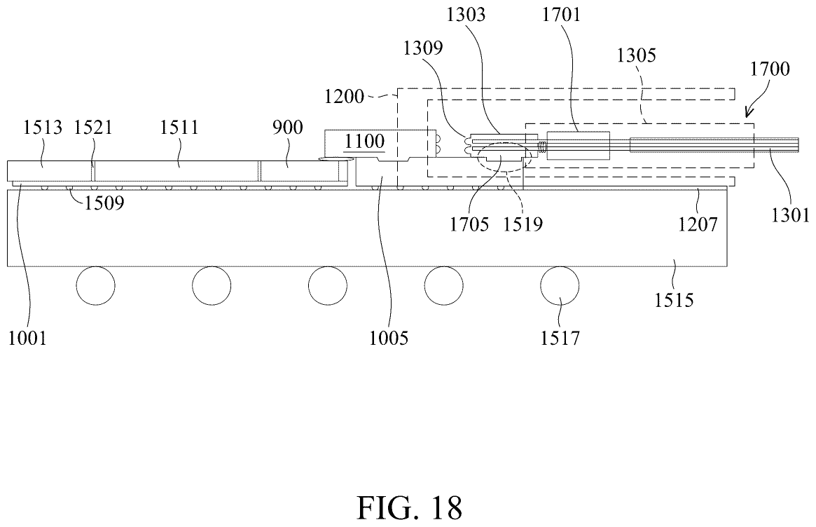

FIG. 18 illustrates an insertion of the second FAU 1700 into the receptacle 1200. As can be seen, as the second FAU 1700 is inserted, the spring push 1701 provides an additional force that forces the sixth alignment features 1705 into the fifth alignment feature 1519, thereby providing a fine alignment for the ferrule 1303.

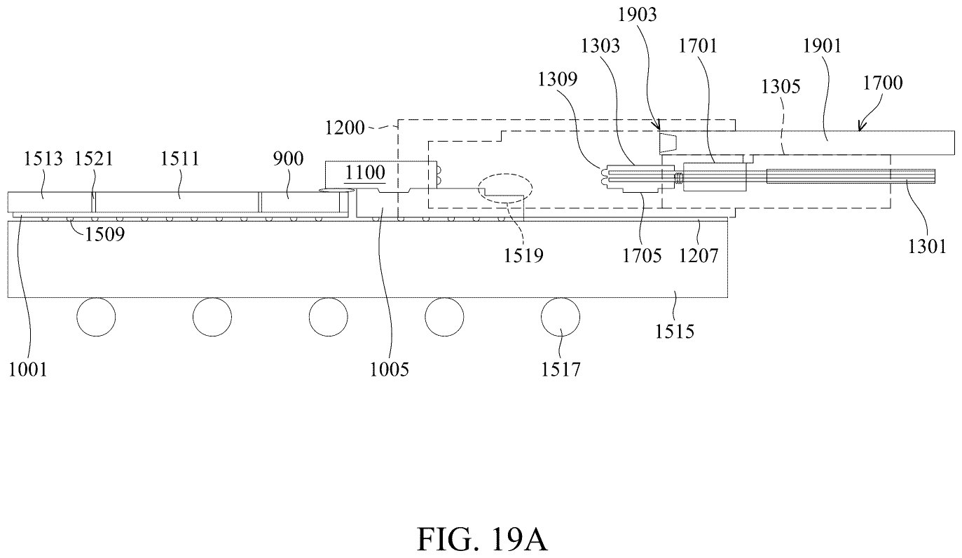

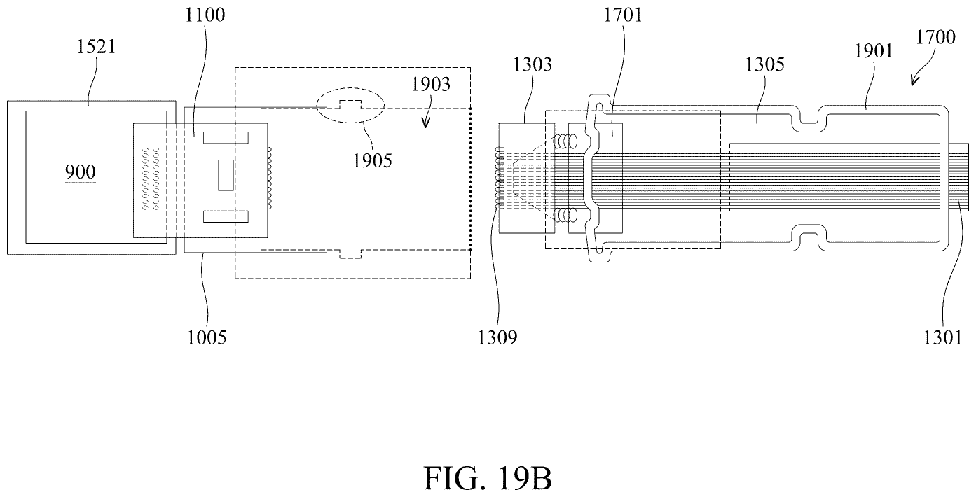

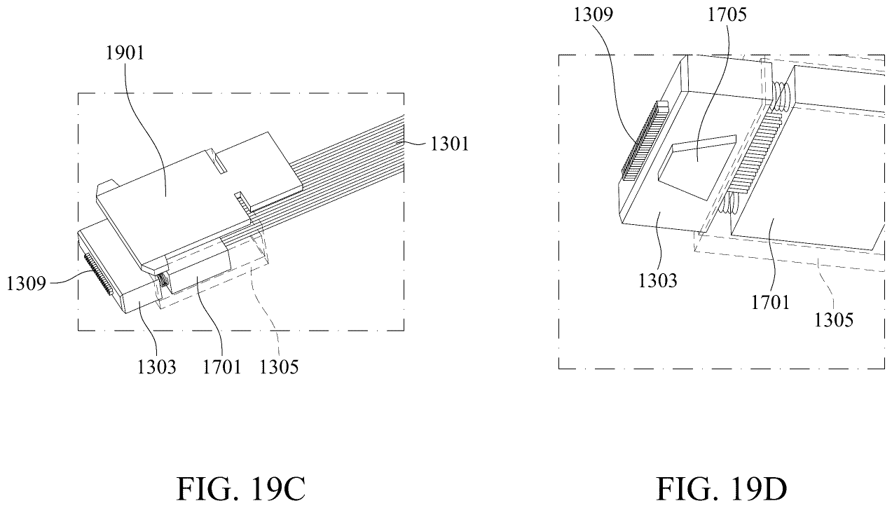

FIGS. 19A-19B illustrates a cross-sectional and top down view, respectively, of another embodiment similar to the embodiment described above with respect to FIGS. 15-18. In this embodiment, however, the second FAU 1700 additionally includes a detachable alignment structure 1901 that is used in order to help provide a coarse alignment to the second FAU 1700 as well as holding the second FAU 1700 in place once inserted.

Also in this embodiment, in order to accommodate the presence of the alignment structure 1901 on the second FAU 1700, the receptacle 1200 may further include a recessed portion 1903. Additionally, and as seen more clearly in the top down view of FIG. 19B, the recessed portion 1903 of the receptacle may further include slots 1905 in order to receive portions of the detachable alignment structure 1901.

FIGS. 19C-19D illustrate additional views of the second FAU 1700. In these views can be seen the sixth alignment features 1705 on the underside of the ferrule 1303 as well as the spring push 1701 and alignment structure 1901 on the second FAU 1700. However, any suitable structures may be utilized.

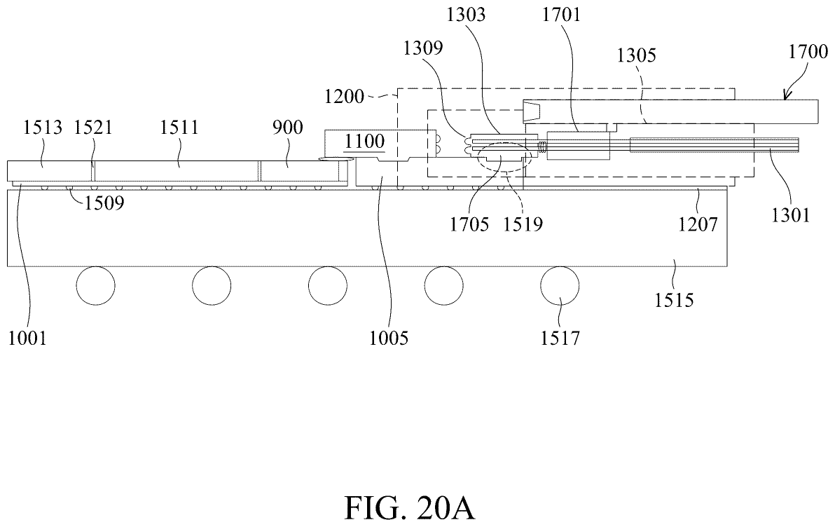

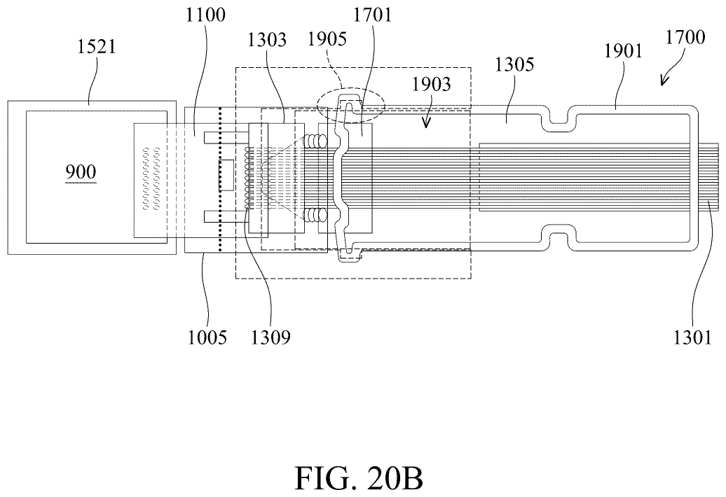

FIGS. 20A-20B illustrates a cross-sectional and top down view, respectively, of the second FAU 1700 being inserted into the receptacle 1200. In this embodiment as the second FAU 1700 is being inserted the detachable alignment structure 1901 is guided by the recessed portion 1903 to provide a coarse alignment to the ferrule 1303. Additionally, once the detachable alignment structure 1901 is inserted far enough, the detachable alignment structure 1901 will enter into the slots 1905, which holds the second FAU 1700 in place.

Additionally, during the insertion the ferrule 1303 will move towards the alignment die 1005, where the sixth alignment features 1705 will interact with the fifth alignment feature 1519. Further, the spring push 1701 will apply an additional force to push the sixth alignment features 1705 into the fifth alignment feature 1519, thereby providing a fine alignment between the ferrule 1303 and the first optical passive device 1100.

By utilizing the various lens combinations between the various devices as described above, the transmission of optical signals can be collimated in to a collimated, larger beam. The larger beam, with its corresponding larger tolerance, allows for the various devices to be aligned using passive methods, such as the usage of the alignment features, instead of requiring a slower, more active measure of alignment. Given this faster approach, along with the detachability of the various devices such as the fiber array unit, the speed of the overall manufacturing process can be improved, thereby increasing the overall yield.

In an embodiment, a method of manufacturing an optical device includes: placing an alignment die adjacent to a first optical package; and attaching a first passive optical device to both the alignment die and the first optical package, wherein a first alignment structure of the first passive optical device is conjoined with a second alignment structure of the alignment die. In an embodiment the method further includes attaching a receptacle to the alignment die, wherein at least one third alignment structure of the receptacle is conjoined with a fourth alignment structure of the alignment die. In an embodiment the first passive optical device comprises a first tier of first optical components and a first mirror. In an embodiment the first passive optical device comprises a second tier of second optical components and a second mirror. In an embodiment the first passive optical device further comprises a first lens aligned with the first mirror and a second lens aligned with the second mirror. In an embodiment the method further includes attaching a fiber array unit to the alignment die, wherein at least one third alignment structure of the fiber array unit is inserted into a fourth alignment structure of the alignment die. In an embodiment a spring push applies a force to insert the at least one third alignment structure into the fourth alignment structure.

In another embodiment, a method of manufacturing an optical device includes: attaching an optical package 900 to a substrate 1001; attaching an alignment die 1005 to the substrate 1001, the alignment die 1005 comprising first alignment features 1009 and second alignment features 1007; inserting third alignment features 1123 of a first passive optical device 1100 into the first alignment features 1009; and inserting fourth alignment features 1205 of a receptacle 1200 into the second alignment features 1009. In an embodiment the attaching the optical package to the substrate further includes: bonding the optical package to an interposer substrate; and bonding the interposer substrate to the substrate. In an embodiment the method further includes bonding a first semiconductor die and a second semiconductor die to the interposer substrate. In an embodiment the method further includes inserting fifth alignment features of a fiber array unit into the receptacle. In an embodiment the method further includes using a spring to help insert a sixth alignment feature of the fiber array unit into a seventh alignment feature of the alignment die. In an embodiment the first passive optical device fully overlies the alignment die in a first cross-section. In an embodiment the first passive optical device does not fully overly the alignment die in a first cross-section.

In yet another embodiment an optical device includes: a first optical package; an alignment die adjacent to the first optical package, the alignment die comprising a first alignment feature; and a first passive optical device overlying both the first optical package and the alignment die, the first passive optical device comprising a second alignment feature conjoined with the first alignment feature. In an embodiment the optical device further includes a receptacle overlying the first passive optical device, the receptacle comprising a third alignment feature, the third alignment feature being located within a fourth alignment feature of the alignment die. In an embodiment the first passive optical device further includes: a first tier comprising first optical components and a first mirror; and a second tier comprising second optical components and a second mirror. In an embodiment the first passive optical device further includes: a first lens aligned with the first mirror; and a second lens aligned with the second mirror. In an embodiment the optical device further includes a fiber array unit, wherein a ferrule of the fiber array unit is located at least in part within a receptacle, the fiber array unit comprising a third alignment feature, the third alignment feature being located within a fourth alignment feature of the alignment die. In an embodiment the optical device further includes: a first lens located on the first passive optical device; and a second lens located on the fiber array unit, the second lens being aligned with the first lens.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. (canceled)

2. An optical device comprising:
an alignment die adjacent to a first optical package; and
a first passive optical device attached to both the alignment die and the first optical package, wherein a first alignment structure of the first passive optical device is conjoined with a second alignment structure of the alignment die.

3. The optical device of claim 2, further comprising a receptacle attached to the alignment die, wherein at least one third alignment structure of the receptacle is conjoined with a fourth alignment structure of the alignment die.

4. The optical device of claim 2, wherein the first passive optical device comprises a first tier of first optical components and a first mirror.

5. The optical device of claim 4, wherein the first passive optical device comprises a second tier of second optical components and a second mirror, the second tier of second optical components is at a different level than the first tier of first optical components.

6. The optical device of claim 2, further comprising a fiber array unit attached to the alignment die, the fiber array unit comprising a third alignment structure inserted into the alignment die.

7. The optical device of claim 2, further comprising an interposer substrate bonded to the first optical package.

8. The optical device of claim 7, further comprising:
a first semiconductor device bonded to the interposer substrate; and
a second semiconductor device bonded to the interposer substrate.

9. An optical device comprising:
an optical package attached to a substrate;
an alignment die attached to the substrate, the alignment die comprising first alignment features and second alignment features;
third alignment features of a first passive optical device inserted into the first alignment features; and
fourth alignment features of a receptacle inserted into the second alignment features.

10. The optical device of claim 9, wherein the first passive optical device comprises a first tier of first optical components and a first mirror.

11. The optical device of claim 10, wherein the first passive optical device comprises a second tier of second optical components and a second mirror, the second tier being different from the first tier.

12. The optical device of claim 11, wherein the first passive optical device further comprises a lens aligned with the second mirror.

13. The optical device of claim 12, wherein the lens is one of a plurality of lenses, the plurality of lenses arranged into two lines.

14. The optical device of claim 13, wherein the substrate is an interposer substrate.

15. The optical device of claim 14, further comprising:
a first semiconductor die bonded to the interposer substrate; and
a second semiconductor die bonded to the interposer substrate.

16. An optical device comprising:
a first passive optical device over a substrate;
an alignment die extending from the substrate to the first passive optical device, wherein a portion of the first passive optical device extends into a recess of the alignment die; and
a first optical package adjacent to the alignment die.

17. The optical device of claim 16, wherein the first passive optical device comprises a first tier of first optical components and a first mirror.

18. The optical device of claim 17, wherein the first passive optical device comprises a second tier of second optical components different from the first tier of first optical components, the second tier further comprising a second mirror.

19. The optical device of claim 18, wherein the first passive optical device further comprises a first lens aligned with the first mirror and a second lens aligned with the second mirror.

20. The optical device of claim 16, further comprising a fiber array unit attached to the alignment die, where a portion of the fiber array unit is inserted into the alignment die.

21. The optical device of claim 16, further comprising a fiber array unit attached to a receptacle, where a portion of the receptacle is inserted into the alignment die.
